(19) United States
(12) Patent Application Publication
(10) Pub. No.: US 2019/0186576 A1
(43) Pub. Date: Jun. 20, 2019

(54) DAMPER DEVICE

(71) Applicant: HONDA MOTOR CO., LTD., Tokyo (JP)

(72) Inventors: Hidekazu TAMAKI, WAKO-SHI (JP); Takumi SATO, WAKO-SHI (JP); Hideki HITOMI, TOCHIGI-KEN (JP); Junko KAWAKAMI, TOCHIGI-KEN (JP)

(21) Appl. No.: 16/219,041

(22) Filed: Dec. 13, 2018

(30) Foreign Application Priority Data
Dec. 15, 2017 (JP) 2017-240668

(51) Int. Cl. F16F 7/104; F16F 15/02; B60N 2/64

(52) U.S. Cl. CPC F16F 7/104; F16F 2222/08; B60N 2/64; F16F 15/022

(57) ABSTRACT

A damper device includes: a case; a weight elastically supported in the case; and a second elastic member that is fixed to a surface of the case that faces the weight. The weight and the second elastic member are separated from each other, and a spring rate of the second elastic member has a nonlinear characteristic.

### CROSS-REFERENCE TO RELATED APPLICATION

This application is based upon and claims the benefit of priority from Japanese Patent Application No. 2017-240668 filed on Dec. 15, 2017, the contents of which are incorporated herein by reference.

### BACKGROUND OF THE INVENTION

### Field of the Invention

The present invention relates to a damper device that is provided on a vibration part of a transport apparatus (for example, vehicle, airplane, and ship) in which vibration, oscillation, or the like easily occurs, and that suppresses the vibration of the vibration part.

### Description of the Related Art

An object of a damper device according to Japanese Laid-Open Patent Publication No. 2009-204123 is to provide a dynamic damper that is reduced in size in left-right and up-down directions so as to be attached to a limited small space, and to elastically support a damper mass stably and regulate displacement of the damper mass in up-down, front-rear, and left-right directions.

To achieve the above object, in the damper device according to Japanese Laid-Open Patent Publication No. 2009-204123, rubber support parts of the dynamic damper are disposed at four corners of the damper mass, and elastically support the damper mass from below. The damper mass includes an extension part and has a thin shape in the up-down direction. The extension part and a pair of elastic support bodies form a stopper mechanism in the left-right direction. An upper bracket and a lower bracket of the elastic support body form the stopper mechanism in the up-down and front-rear directions.

### SUMMARY OF THE INVENTION

In Japanese Laid-Open Patent Publication No. 2009-204123, the rubber support part made of a rubber elastic body that elastically supports the damper mass is provided between the damper mass of the dynamic damper and a vibration part of a vehicle.

In general, the single inertance (acceleration characteristic) of a seat back frame has substantially the same frequency in large input (for example, 100 N) and small input (30 N).

However, since a member that elastically supports the damper mass is formed by rubber, the single inertance of the dynamic damper has different resonance frequencies in the large input and the small input.

Therefore, conventionally, an eigenvalue only can be controlled in the small input or the large input, not both.

The present invention has been made in order to solve the above problem and an object is to provide a damper device in which a characteristic of a dynamic damper varies depending on response amplitude with respect to input, and the dynamic damper effect the can be obtained in both the large input and the small input on an actual road.

[1] A damper device according to an aspect of the present invention includes: a case; a weight elastically supported in the case; and an elastic member that is fixed to a surface of the case that faces the weight, wherein: the weight and the elastic member are separated from each other; and a spring rate of the elastic member has a nonlinear characteristic.

Therefore, if vibration (road surface input) from a road surface is small, the spring rate becomes low, and if the input is large, the spring rate becomes high. That is to say, the damper device has a structure in which a characteristic of a dynamic damper varies depending on response amplitude with respect to the input. Thus, change of an eigenvalue of the dynamic damper due to amplitude dependence, which is inherent in the dynamic damper, is suppressed. As a result, in the large input and the small input, frequencies of the dynamic damper do not shift and become an optimum value. That is to say, even on an actual road, the effect of the dynamic damper can be obtained in both the large input case and the small input case.

[2] In the aspect of the present invention, the case may include a plurality of side plates that face each other, and the elastic member may be fixed to a surface of each of the side plates that faces the weight.

The side plates are provided in order to prevent a portion that elastically supports the weight from being cut when the amplitude becomes large in rough road traveling, for example. The elastic member can be fixed by using the side plates. As a result, no dedicated component for attaching the elastic member is required, and thus it is possible to prevent the number of components from increasing.

[3] In the aspect of the present invention, the elastic member may be a conical spring, and the elastic member may be fixed so that a portion of the elastic member that has smaller diameter faces the weight.

The spring rate of the conical spring has a characteristic in which, as deflection (displacement) increases, a load increases exponentially, that is, a nonlinear characteristic. Therefore, if the road surface input is small, the spring rate becomes low, and if the road surface input is large, the spring rate becomes high. Thus, change of the eigenvalue of the dynamic damper due to the amplitude dependence, which is inherent in the dynamic damper, can be prevented. Since the spring rate has the nonlinear characteristic, it is possible to deal with a wide range of amplitude input.

[4] In the aspect of the present invention, the elastic member may include a plurality of coil springs with different diameters and lengths.

In a case where the coil springs with different diameters and lengths include, for example, a first coil spring with large diameter and long length and a second coil spring with small diameter and short length, when the deflection is small, the characteristic of only the first coil spring appears. That is to say, as the deflection increases, the load increases along a certain inclination. As the deflection increases more, the characteristic obtained by combining the characteristic of the first coil spring with the characteristic of the second coil spring appears. That is to say, as the deflection increases, the load increases along an inclination that is larger than the above inclination. That is to say, the spring rate has the nonlinear characteristic.

Therefore, if the road surface input is small, the spring rate becomes low, and if the road surface input is large, the spring rate becomes high. Thus, the change of the eigenvalue of the dynamic damper due to the amplitude dependence, which is inherent in the dynamic damper, can be prevented. Since the spring rate has the nonlinear characteristic, it is possible to deal with a wide range of amplitude input.

[5] In the aspect of the present invention, the elastic member may include a rubber member and may have a shape in which a cross-sectional area becomes smaller toward the weight.

Even in this case, similarly to the conical spring, the spring rate has the characteristic in which, as the deflection increases, the load increases exponentially, that is, the nonlinear characteristic. Therefore, if the road surface input is small, the spring rate becomes low, and if the road surface input is large, the spring rate becomes high. Thus, change of the eigenvalue of the dynamic damper due to the amplitude dependence, which is inherent in the dynamic damper, can be prevented. Since the spring rate has the nonlinear characteristic, it is possible to deal with a wide range of amplitude input.

In the damper device according to the present invention, the characteristic of the dynamic damper varies depending on the response amplitude with respect to the input, and the effect of the dynamic damper can be obtained in both the large input and the small input on the actual road.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view illustrating a seat device (mainly, frame structure) that includes a damper device according to the present embodiment;

FIG. 2A is a front view illustrating a first damper device;

FIG. 2B is a right side view illustrating the first damper device;

FIG. 2C is a graph showing a spring rate of a conical spring;

FIG. 3A is an explanatory view showing a hammering test for a single seat back frame;

FIG. 3B is a graph showing an inertance characteristic of the single seat back frame in large input (150 N) and small input (30 N);

FIG. 4A is an explanatory view showing the hammering test for a damper device according to a comparative example;

FIG. 4B is a graph showing the inertance characteristic of the single damper device (comparative example) in the large input (100 N) and the small input (20 N);

FIG. 5A is a graph showing the inertance characteristic of the seat back frame with the damper device (comparative example) in the large input (150 N) and the small input (30 N);

FIG. 5B is a graph showing the inertance characteristic of the seat back frame with the damper device (example of the embodiment) in the large input (150 N) and the small input (30 N);

FIG. 6A is a front view illustrating a second damper device;

FIG. 6B is an explanatory view illustrating a structure example of a double coil spring;

FIG. 6C is a graph showing the spring rate of the double coil spring;

FIG. 7A is a front view illustrating a third damper device;

FIG. 7B is an explanatory view illustrating one example of a second elastic member that is made up of a rubber member (triangular column shape); and

FIG. 7C is a graph showing the spring rate of the second elastic member that is made up of the rubber member.

### DESCRIPTION OF THE PREFERRED EMBODIMENTS

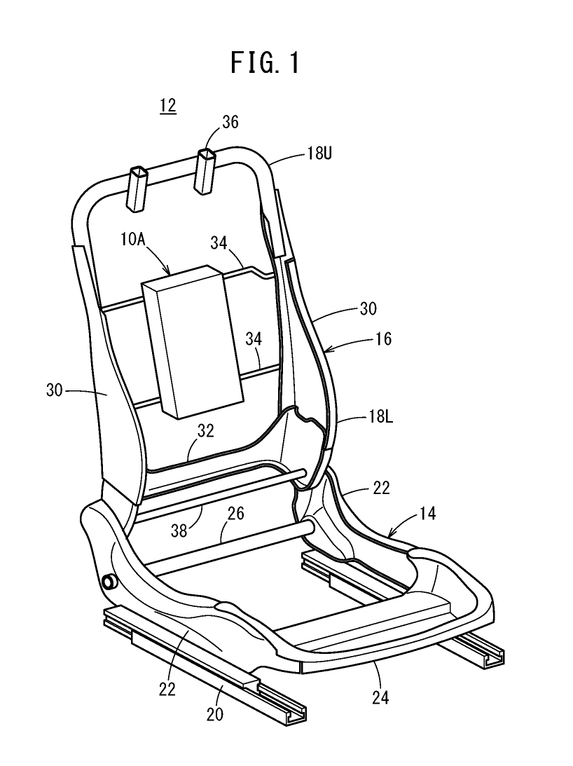

Description is hereinafter given of embodiments of a damper device according to the present invention with reference to FIG. 1 to FIG. 7C.

For example, as illustrated in FIG. 1, the damper device according to a first embodiment (first damper device 10A) is installed on a seat device 12.

The seat device 12 includes at least a seat cushion frame 14 and a seat back frame 16. The seat back frame 16 includes a lower seat back frame 18L that is rotatably attached to the seat cushion frame 14, and an upper seat back frame 18U that is fixed to an upper part of the lower seat back frame 18L by welding, for example.

The seat device 12 is provided so as to be slidable in, for example, a front-rear direction by brackets 20 that are provided on a floor or the like of a transport apparatus such as a vehicle, a ship, or an airplane. Needless to say, the seat device 12 may be fixed to the floor or the like without sliding.

The seat cushion frame 14 includes a pair of left and right cushion side frames 22 that extend in the front-rear direction, a front frame 24 that is extended between front parts of the cushion side frames 22, a rear frame 26 that is extended between rear parts of the cushion side frames 22, and the like. Thus, the seat cushion frame 14 has a frame shape. The bracket 20 is attached to each cushion side frame 22.

The lower seat back frame 18L includes a pair of left and right back side frames 30 that extends in an approximately up-down direction, a back lower frame 32 that is extended between lower ends of the left and right back side frames 30, and reinforcement poles 34 that are extended respectively between upper parts of the back side frame 30 and between lower parts of the back side frame 30. Thus, the lower seat back frame 18L has a frame shape. The back lower frame 32 is connected to the lower parts of the back side frames 30 by welding, for example.

The upper seat back frame 18U has an inverted U-letter shape. Each end of the upper seat back frame 18U is connected to the upper part of the lower seat back frame 18L by welding, for example. The upper seat back frame 18U has two tubular holders 36 fixed on a central part thereof, through which stays of a headrest are inserted.

Note that a rear part of the seat cushion frame 14 and a lower part of the lower seat back frame 18L are provided with a support shaft 38 that supports the lower seat back frame 18L in a manner that the lower seat back frame 18L is rotatable with respect to the seat cushion frame 14. For example, the lower part of the lower seat back frame 18L is rotatably connected to an inner side of the rear part of the cushion side frame 22.

Then, as described above, the first damper device 10A is provided to the seat device 12. The first damper device 10A may be provided to any part of the seat device 12. However, in order to suppress vibration of the seat back frame 16, for example, it is preferable that the first damper device 10A is disposed on a central part of the seat back frame 16, for example. In the present embodiment, the first damper device 10A is arranged on the central part of the upper seat back frame 18U so that the first damper device 10A is extended between central parts of the reinforcement poles 34, for example.

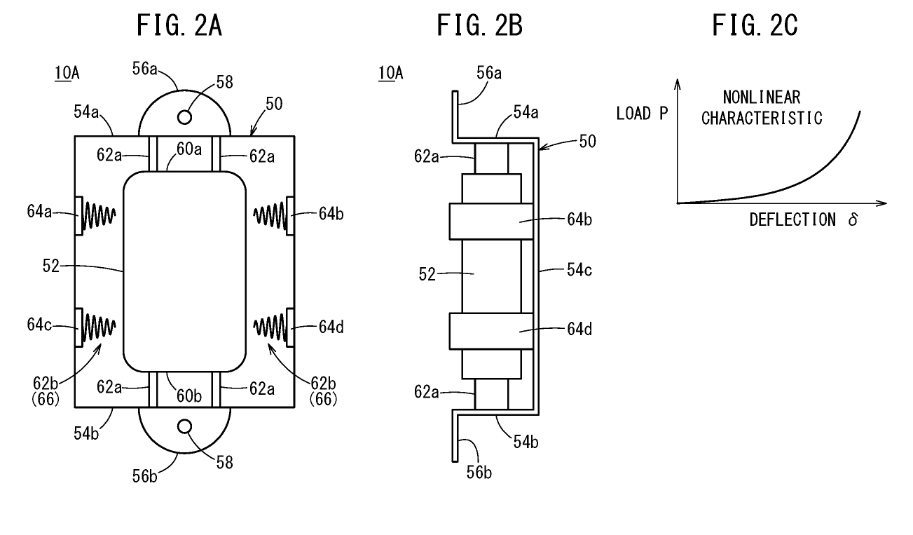

As illustrated in FIG. 2A and FIG. 2B, the first damper device 10A includes a case 50, and a weight 52 that is elastically held at a central part of the case 50.

The case 50 is formed by integrating an upper plate 54a, a lower plate 54b, and a back plate 54c that are made of metal through a sheet metal working of a metal plate, for example. In this case, the upper plate 54a projects forward from an upper end of the back plate 54c, and the lower plate 54b projects forward from a lower end of the back plate 54c. That is to say, the upper plate 54a and the lower plate 54b face each other.

In one example, the back plate 54c has a length of 70 mm in a horizontal direction (left-right direction), the back plate 54c has a length of 110 mm in a vertical direction (up-down direction), and the upper plate 54a and the lower plate 54b have a depth of 30 mm (length in front-rear direction). In addition, the weight 52 has a length of 50 mm in the horizontal direction (left-right direction), a length of 90 mm in the vertical direction (up-down direction), and a height of 20 mm (length in front-rear direction).

To a front end of the upper plate 54a, for example, an upper attachment plate 56a with a semicircular shape that is made of metal is attached integrally. Similarly, to a front end of the lower plate 54b, for example, a lower attachment plate 56b with a semicircular shape that is made of metal is also attached integrally. Each of the upper attachment plate 56a and the lower attachment plate 56b has a screw hole 58 on a central part thereof. Therefore, for example, the damper device can be fixed to the reinforcement poles 34 of the seat back frame 16 or the like by inserting screws (not shown) into the screw holes 58.

The upper plate 54a of the case 50 and an upper surface 60a of the weight 52 are connected to each other through two first elastic members 62a each having a plate shape.

Similarly, the lower plate 54b of the case 50 and a lower surface 60b of the weight 52 are connected to each other through two first elastic members 62a. Each first elastic member 62a has a plate shape, and is provided so that a thickness direction of the first elastic member 62a coincides with the left-right direction of the case 50, and a surface direction of the first elastic member 62a coincides with the front-rear direction of the case 50. In one example, the first elastic member 62a has a length of 10 mm (length in up-down direction), a thickness of 3 mm (length in left-right direction), and a depth of 15 mm (length in front-rear direction). Note that the first elastic member 62a is not fixed to the back plate 54c.

Furthermore, the case 50 is integrated with four side plates (first side plate 64a to fourth side plate 64d) that face each other, for example. FIG. 2A illustrates an example in which the first side plate 64a and the third side plate 64c face each other, and the second side plate 64b and the fourth side plate 64d face each other. In this case, inner surfaces of the first side plate 64a and the third side plate 64c face one side surface of the weight 52, and inner surfaces of the second side plate 64b and the fourth side plate 64d face the other side surface of the weight 52. Note that the number of side plates is not limited to four. Two side plates may be provided so as to face each other, or six or more side plates may be provided so as to face each other.

Each of the first side plate 64a to the fourth side plate 64d has a second elastic member 62b fixed to a surface thereof that faces the weight 52 using an adhesive, for example. In a natural state, the weight 52 and the second elastic member 62b are separated from each other, that is, are not in contact with each other.

Each second elastic member 62b is a conical spring 66, and fixed so that a smaller-diameter portion of the elastic member faces the weight 52. As illustrated in FIG. 2C, a spring rate of the conical spring 66 has a characteristic in which, as deflection (displacement) δ increases, a load P increases exponentially, that is, a nonlinear characteristic.

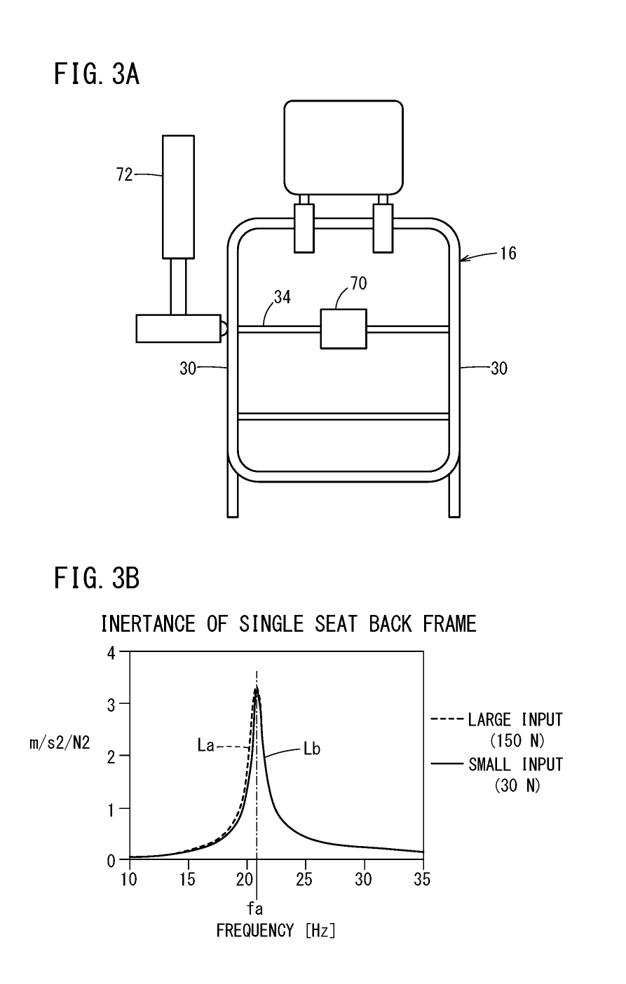

Here, description is given of an experiment example regarding the first damper device 10A and a comparative example with reference to FIG. 3A and FIG. 3B.

First, as illustrated in FIG. 3A, a hammering test for the single seat back frame 16 (made of iron) was performed. In the hammering test, at the central part of the seat back frame 16, for example, the central part of the upper reinforcement pole 34, a G meter 70 was fixed. Then, a portion of one back side frame 30 at the same height as the position at which the G meter 70 was fixed was hit with a hammer 72. This result is shown in FIG. 3B.

In FIG. 3B, a curved line La expresses an inertance characteristic of the single seat back frame 16 in the case of large input (150 N), and similarly, a curved line Lb expresses the inertance characteristic in the case of small input (30 N).

The result in FIG. 3B shows that the inertance characteristics of the single seat back frame 16 in the large input and the small input are substantially the same, and peak frequencies fa (optimum value) are also substantially the same. That is to say, the inertance characteristics of the single seat back frame 16 hardly depend on amplitude.

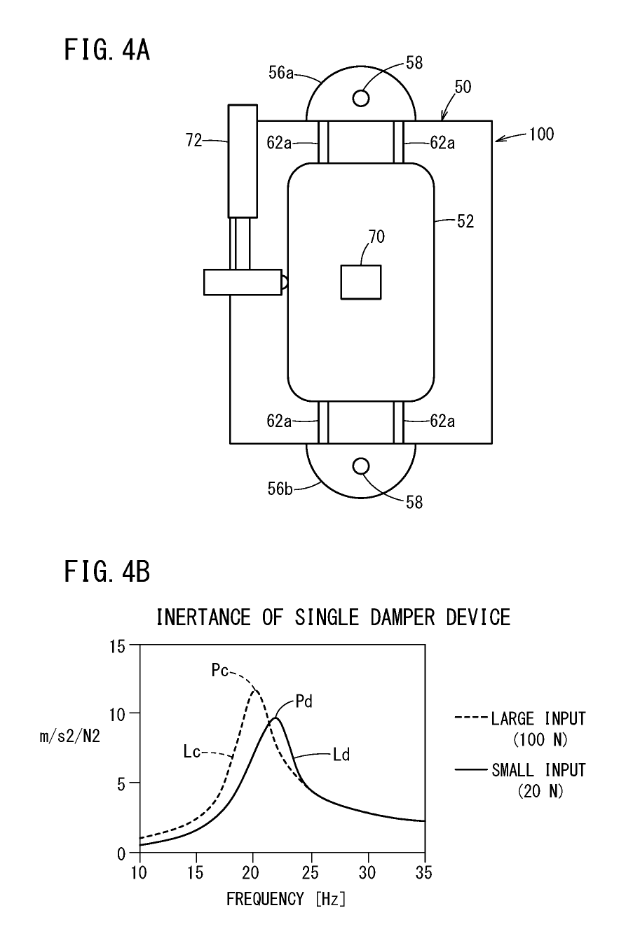

Next, the hammering test for a damper device 100 according to the comparative example was performed. As illustrated in FIG. 4A, in the damper device 100 according to the comparative example, the case 50 includes neither the four side plates (first side plate 64a to fourth side plate 64d) nor the second elastic members 62b (see FIG. 2A). In the hammering test, the G meter 70 was fixed to a central part of the weight 52, and a center of one side surface of the weight 52 was hit with the hammer 72. This result is shown in FIG. 4B.

In FIG. 4B, a curved line Lc expresses the inertance characteristic of the single damper device in the case of the large input whose amplitude is large (100 N), and similarly, a curved line Ld expresses the inertance characteristic in the case of the small input whose amplitude is small (20 N).

The result in FIG. 4B shows that, in the inertance characteristics of the single damper device 100 (comparative example), a peak Pc of the inertance in the large input is greater than a peak Pd of the inertance in the small input, and the peak frequencies of the peak Pc and the peak Pd are also different largely.

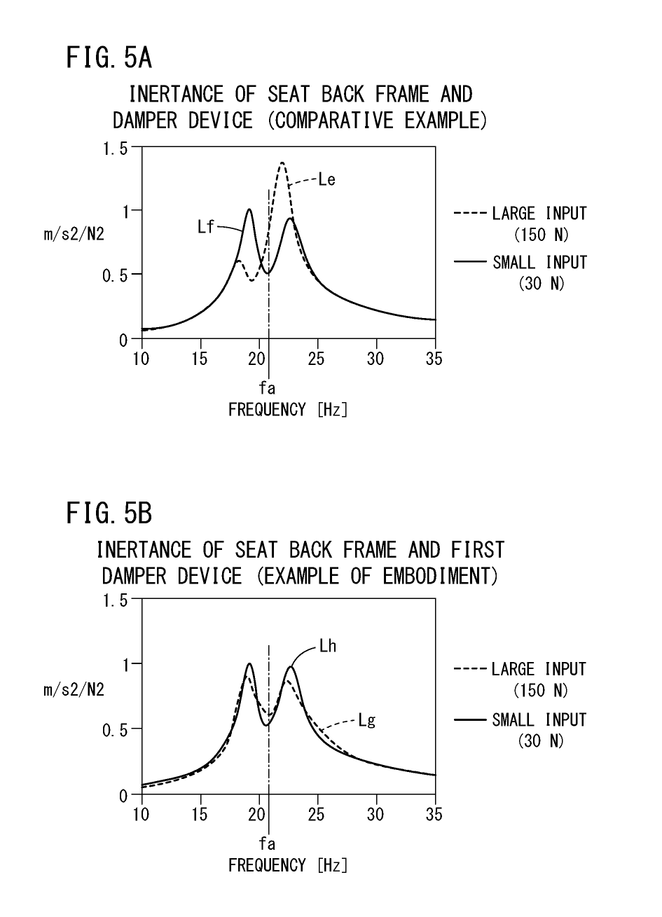

Next, the damper device 100 according to the comparative example and the G meter 70 were fixed to the central part of the seat back frame 16, and the hammering test was performed similarly to the above example. This result is shown in FIG. 5A.

In FIG. 5A, a curved line Le expresses the inertance characteristic of the seat back frame 16 with the damper device (comparative example) in the case of the large input (150 N), and a curved line Lf expresses the inertance characteristic in the case of the small input (30 N).

According to the result in FIG. 5A concerning the inertance characteristics of the seat back frame 16 with the damper device (comparative example), the inertance in the small input has a local minimum value at the peak frequency fa (optimum value: see FIG. 3B) of the single seat back frame 16, while the inertance in the large input has a local minimum value at a frequency that is lower than the peak frequency fa.

That is to say, in the damper device 100 according to the comparative example, there is a difference in amplitude dependence between the seat back frame 16 and the damper device 100. Therefore, it is understood that the effect of a dynamic damper (vibration suppressing effect) only can be obtained in one of the large input and the small input. The result in FIG. 5A shows that the damper device 100 according to the comparative example has the vibration suppressing effect only in the small input case on an actual road.

Next, the damper device (first damper device 10A) according to the embodiment and the G meter 70 were fixed to the central part of the seat back frame 16, and the hammering test was performed similarly to the above example. This result is shown in FIG. 5B.

In FIG. 5B, a curved line Lg expresses the inertance characteristic of the seat back frame 16 with the first damper device 10A (embodiment) in the case of the large input (150 N), and a curved line Lh expresses the inertance characteristic in the case of the small input (30 N).

According to the result in FIG. 5B concerning the inertance characteristics of the seat back frame 16 with the first damper device 10A (embodiment), both the inertances in the small input case and the large input case have local minimum values at the peak frequency fa (optimum value: see FIG. 3B) of the single seat back frame 16.

That is to say, in the first damper device 10A, the characteristic of the dynamic damper varies depending on response amplitude with respect to the input. Therefore, there is little amplitude dependence between the seat back frame 16 and the first damper device 10A. Thus, the effect of the dynamic damper (vibration suppressing effect) can be obtained in both the large input case and the small input case. The result in FIG. 5B shows that, the first damper device 10A (embodiment) has the vibration suppressing effect both in the large input case and the small input case on an actual road.

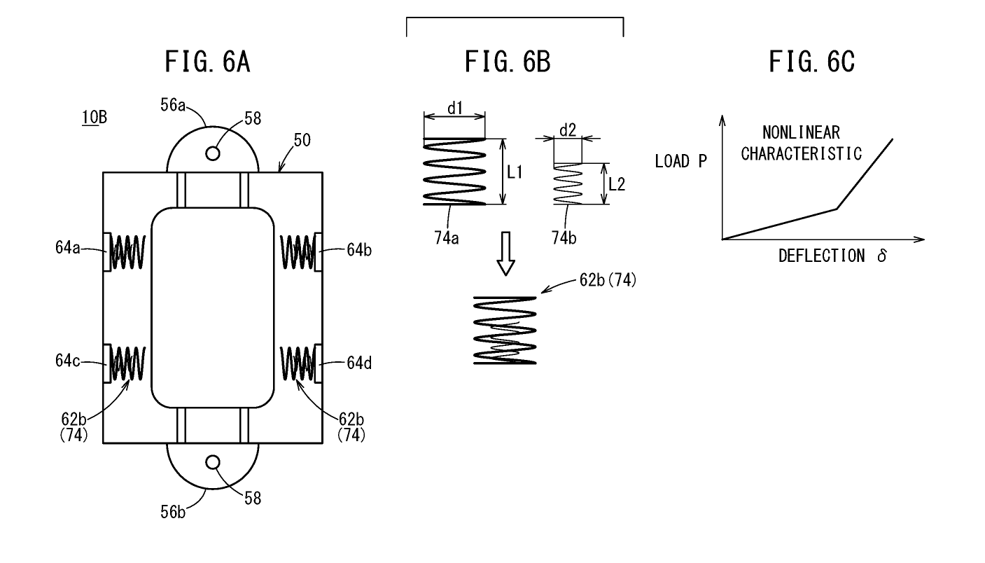

Next, description is given of a damper device (second damper device 10B) according a second embodiment with reference to FIG. 6A to FIG. 6C.

As illustrated in FIG. 6A, the second damper device 10B has a structure that is similar to that of the first damper device 10A as described above, but differs from the first damper device 10A in that each of the second elastic members 62b includes a plurality of coil springs with different diameters and lengths.

FIG. 6A and FIG. 6B show an example in which the second elastic member 62b includes a double coil spring 74. In the double coil spring 74, for example, a first coil spring 74a is arranged inside a second coil spring 74b. In one example of the diameter and the length of the double coil spring 74, when the diameter and the length of the first coil spring 74a are denoted respectively by dl and L1, and the diameter and the length of the second coil spring 74b are denoted respectively by d2 and L2, these diameters and lengths satisfy the following relations.

d1>d2

L1>L2

FIG. 6C shows the spring rate of the second elastic member 62b (double coil spring 74) of the second damper device 10B. When the deflection δ is small, the characteristic of only the first coil spring 74a appears. That is to say, as the deflection δ increases, the load P increases along a certain inclination. As the deflection δ increases more, the characteristic containing the characteristic of the first coil spring 74a and the characteristic of the second coil spring 74b in combination appears. In this case, as the deflection δ increases, the load P increases along an inclination that is larger than the above inclination. That is to say, the spring rate has a nonlinear characteristic, which is similar to that of the second elastic member 62b (conical spring 66) of the first damper device 10A.

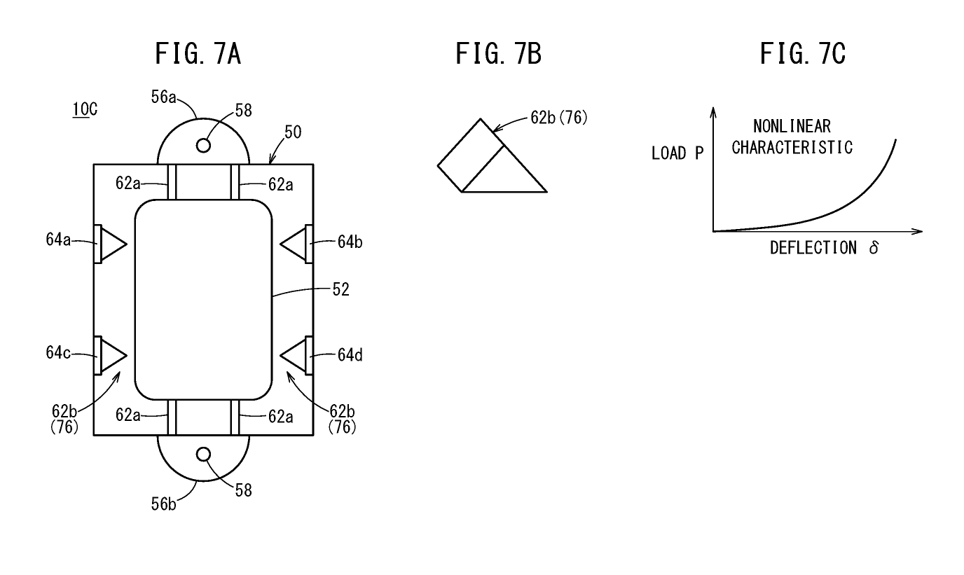

Next, description is given of a damper device (third damper device 10C) according a third embodiment with reference to FIG. 7A to FIG. 7C.

As illustrated in FIG. 7A and FIG. 7B, the third damper device 10C has a structure that is similar to that of the first damper device 10A as described above except that the second elastic member 62b is made up of a rubber member 76 and has a shape in which a cross-sectional area becomes smaller toward the weight 52, for example a triangular column shape (see FIG. 7B).

As illustrated in FIG. 7C, similarly to the conical spring 66, the spring rate of the second elastic member 62b of the third damper device 10C has a characteristic in which, as the deflection δ increases, the load P increases exponentially, that is, a nonlinear characteristic.

Examples of the shape of the second elastic member 62b include, in addition to the triangular column shape as shown in FIG. 7B, a conical shape, a truncated conical shape, and a hemispherical shape, for example.

As described above, the damper device according to the present embodiment includes: the case 50; the weight 52 elastically supported in the case 50; and the second elastic member 62b that is fixed to the surface of the case 50 that faces the weight 52. The weight 52 and the second elastic member 62b are separated from each other, and the spring rate of the second elastic member 62b has the nonlinear characteristic.

Therefore, if the vibration (road surface input) from the road surface is small, the spring rate becomes low, and if the input is large, the spring rate becomes high. That is to say, the damper device has the structure in which the characteristic of the dynamic damper varies depending on the response amplitude with respect to the input. Thus, change of the eigenvalue of the dynamic damper due to the amplitude dependence, which is inherent in the dynamic damper, is suppressed. As a result, in the large input and the small input, the frequencies of the dynamic damper do not shift and become an optimum value. That is to say, even on the actual road, the effect of the dynamic damper can be obtained in both the large input case and the small input case.

In the present embodiment, the case 50 includes the plurality of side plates (64a to 64d) that face each other, and the second elastic member 62b is fixed to the surface of each of the side plates that faces the weight 52.

The side plates (64a to 64d) are provided in order to prevent a portion (first elastic member 62a) that elastically supports the weight 52 from being cut when the amplitude becomes large in the rough road traveling, for example. The second elastic member 62b can be fixed by using the side plates. As a result, no dedicated component for attaching the second elastic member 62b is required, and thus it is possible to prevent the number of components from increasing.

In the present embodiment, the second elastic member 62b is the conical spring 66, and the second elastic member 62b is fixed so that the portion of the elastic member having smaller diameter faces the weight 52.

The spring rate of the conical spring 66 has the characteristic in which, as the deflection δ increases, the load P increases exponentially, that is, the nonlinear characteristic. Therefore, if the road surface input is small, the spring rate becomes low, and if the road surface input is large, the spring rate becomes high. Thus, change of the eigenvalue of the dynamic damper due to the amplitude dependence, which is inherent in the dynamic damper, can be prevented. Since the spring rate has the nonlinear characteristic, it is possible to deal with a wide range of amplitude input.

In the present embodiment, the second elastic member 62b includes the plurality of coil springs 74a, 74b with different diameters and lengths.

In the case where the coil springs 74a, 74b with different diameters and lengths include, for example, the first coil spring 74a with the large diameter and the long length and the second coil spring 74b with the small diameter and the short length, when the deflection δ is small, the characteristic of only the first coil spring 74a appears. That is to say, as the deflection δ increases, the load P increases along a certain inclination. As the deflection δ increases more, the characteristic obtained by combining the characteristic of the first coil spring 74a with the characteristic of the second coil spring 74b appears. That is to say, as the deflection δ increases, the load P increases along an inclination that is larger than the above inclination. That is to say, the spring rate has the nonlinear characteristic.

Therefore, if the road surface input is small, the spring rate becomes low, and if the road surface input is large, the spring rate becomes high. Thus, the change of the eigenvalue of the dynamic damper due to the amplitude dependence, which is inherent in the dynamic damper, can be prevented. Since the spring rate has the nonlinear characteristic, it is possible to deal with a wide range of amplitude input.

In the present embodiment, the second elastic member 62b is made up of the rubber member 76 and has a shape in which the cross-sectional area becomes smaller toward the weight 52.

Even in this case, similarly to the conical spring 66, the spring rate has the characteristic in which, as the deflection δ increases, the load P increases exponentially, that is, the nonlinear characteristic. Therefore, if the road surface input is small, the spring rate becomes low, and if the road surface input is large, the spring rate becomes high. Thus, change of the eigenvalue of the dynamic damper due to the amplitude dependence, which is inherent in the dynamic damper, can be prevented. Since the spring rate has the nonlinear characteristic, it is possible to deal with a wide range of amplitude input.

The present invention is not limited to the embodiments above, and can be changed freely within the range not departing from the concept of the present invention.

What is claimed is:

1. A damper device comprising:
a case;
a weight elastically supported in the case; and
an elastic member that is fixed to a surface of the case that faces the weight, wherein:
the weight and the elastic member are separated from each other; and
a spring rate of the elastic member has a nonlinear characteristic.

2. The damper device according to claim 1, wherein:
the case includes a plurality of side plates that face each other; and
the elastic member is fixed to a surface of each of the side plates that faces the weight.

3. The damper device according to claim 1, wherein:
the elastic member is a conical spring; and
the elastic member is fixed so that a portion of the elastic member that has smaller diameter faces the weight.

4. The damper device according to claim 2, wherein:
the elastic member is a conical spring; and
the elastic member is fixed so that a portion of the elastic member that has smaller diameter faces the weight.

5. The damper device according to claim 1, wherein the elastic member includes a plurality of coil springs with different diameters and lengths.

6. The damper device according to claim 2, wherein the elastic member includes a plurality of coil springs with different diameters and lengths.

7. The damper device according to claim 1, wherein the elastic member includes a rubber member and has a shape in which a cross-sectional area becomes smaller toward the weight.

8. The damper device according to claim 2, wherein the elastic member includes a rubber member and has a shape in which a cross-sectional area becomes smaller toward the weight.
